(19) United States
(12) Patent Application Publication
(10) Pub. No.: US 2016/0350780 A1
(43) Pub. Date: Dec. 1, 2016

(54) METHOD AND SYSTEM FOR REFERRING PRODUCTS THROUGH SOCIAL NETWORKS AND EARNING REWARDS

(71) Applicants: Balaji G, Bangalore (IN); Baradwaaj R, Bangalore (IN); Naresh Guniputi, Bengaluru (IN)

(72) Inventors: Balaji G, Bangalore (IN); Baradwaaj R, Bangalore (IN); Naresh Guniputi, Bengaluru (IN)

(21) Appl. No.: 14/724,701

(22) Filed: May 28, 2015

(51) Int. Cl. G06Q 30/02; G06Q 50/00

(52) U.S. Cl. CPC G06Q 30/0214; G06Q 50/01

(57) ABSTRACT

The present application discloses a method and system for referring products through social networks. The application discloses a method to keep track of the entire revere tee through the referral link and rewarding boat the referrer and the purchaser when a purchase effected through that reference. Besides, the receiver of the reference is also getting rewarded for the purchase made by the purchaser, when the receiver and purchaser are different persons,

### FIELD OF THE INVENTION

Embodiments of the present disclosure relates generally to sharing and recommendation of products/services and in particular to a method and system for referring products/services through social networks and earning rewards for the same. The present application further discloses a method and system for tracking and rewarding the referrer and the purchaser through the referral link shared between the referrer, receiver and purchaser (if the purchaser is not the same as receiver). Hence facilitates the users to monetize their social media network.

### BACKGROUND OF THE INVENTION

E-commerce has gained momentum in the recent years due to its unique advantages over the conventional marketing system. The online marketing platforms provide instant access for the consumers to interact with the mercantile community and purchase products online. Besides making purchase the consumers may obtain valuable market information which includes pricing details, competitor information, consumer reviews, ratings and feedbacks from around the world.

Among the available online communication channels, the Social media networks became popular due to their ease of use, wide network and connectivity among the public. Referring products, services and employment through social network has become prevalent in the recent years. It is easy and convenient for a user to recommend a product/service through the social networks than through other modes of communication such as email and messages. Besides, it is economical for the business community too to market and advertise their products through these social media platforms which ensures greater reach and wide connectivity. The users can conveniently recommend, interact and share their experience and views with their contacts through the social media websites than other available online networks.

References and recommendations include anonymous recommendations and recommendation by friends. The anonymous recommendation may or may not influence the buying decision, since the referrer is not known to the receiver or potential purchaser. But reference from someone in close circle or someone known well to the purchaser can make its impact upon the buying decision of receiver or potential purchaser. To be precise, the mutual trust, friendship and relation between the referrer and the receiver, the genuineness of the reference are the factors that can influence a consumer in his/her decision to buy.

Generally, a referrer who wishes to recommend a product/service to his friends in social network needs to share the product details and/or the product purchase link with friends through the available communication services which include email, blogs and social networks. However, such sharing may not be convenient to both the referrer and the friend. Moreover it is not easy for an online vendor/merchant to identify the referrer, reward the referrer and keep track of the reference since the propagation of such online references are not easily traceable one when done in an un-organized manner.

In general, with the existing e-commerce platforms for recommending products and services only the purchaser is getting rewarded for their purchases and not the referrer. Except the famous bloggers and people with huge fan club other referrers finds it difficult to monetize their referrals through social networks. Moreover, most of the available online e-commerce platforms offers open access to the users through which anybody can rate and comment on any of the products or services available online. The authenticity and genuineness of such comments cannot be assured and the intended consumer may not go by such expressed reviews or feedback since it is open to all without any accountability for passing the comments. Moreover, in the conventional e-commerce websites/platforms users are not connected to one another and do not share any relation with those who are rating or reviewing the products.

Hence, there is a need for an e-commerce/online platform which provides easy access to its users to genuinely recommend products or services online besides ensuring monetary benefit/reward for such reference to both the referrer and the purchaser on purchase. The system also required to track the referral link to identify the referrer and the purchaser.

The inconveniences noticed with the existing system of recommending products through online have been minimized to a greater extent with this present system of application which ensures monetary benefit to the referrer as well as to the purchaser and helping them to monetize their references through their social media contacts. With the present method and system of this disclosure, a user can easily register in the website and can recommend products to his contacts/friends online through the available popular social media channels. Since the references are done by the registered users under this system among their contacts, the genuineness of the reference is ensured. The system under this application also keep track of such references and provide rewards/monetary benefits to both the referrer and purchaser and encourage further by rewarding incentives and additional rewards by adopting a multiplier scheme for subsequent references and purchases.

### SUMMARY OF THE INVENTION

The present disclosure describes and claims a method and system for product and/or service recommendation and earning cash-backs by sharing the product/service URL (Uniform Resource Locator)/link with the others in the network. In one embodiment of the present disclosure, a first user referring a product/service (referrer) and a second user (receiver) referred by the first user gets a cash-back or rewards upon purchase of the recommended product/service by the receiver or any third person wherein the third person may be a network member of the receiver, friends of the network members or may be anyone who sees the recommendation. The said system comprises of a central server which converts the product/service URL into affiliate URL comprising traceable information of both referrer and the receiver. On the other hand, the central server maintains details of recommendations made by each referrer/user wherein the details of recommendation includes but not limited to number of recommendations made by the user, number of recommendations consumed, recommendation history (product/service, product/service value, date etc) over a period of time, purchase transactions, other referral activities over the social hub etc. Based on the above mentioned parameters the central server allocates a cash-back to the referrer.

Accordingly, the various embodiments described herein solve the limitations of the prior art and discloses a novel method and system for making product and/or service recommendations.

### BRIEF DESCRIPTION OF THE DRAWING

FIG. 1 is a block diagram of an example recommendation system illustrating a recommendation flow in one embodiment of the present disclosure.

FIG. 2 is a block diagram illustrating the operation of the product/service recommendation in one embodiment of the present disclosure.

FIG. 3 is an example product/service window showing social hub plug-in in one embodiment of the present disclosure.

FIG. 4A is an example social hub platform window enabling the referrer to select one or more receivers/recipients in one embodiment of the present disclosure.

FIG. 4B illustrates an example system for affiliate URL generation in one embodiment of the present disclosure.

FIG. 5 is an example social network page displaying the recommendation in one embodiment of the present disclosure.

FIG. 6 illustrates an example recommendation flow in one embodiment of the present disclosure.

FIG. 7 illustrates another example recommendation flow in one embodiment of the present disclosure.

FIG. 8 illustrates an example of multiple recommendations flow in one embodiment of the present disclosure.

### DETAILED DESCRIPTION OF THE INVENTION

The embodiments herein and the various features and advantageous details thereof are explained more fully with reference to the non-limiting embodiments that are illustrated in the accompanying drawings and detailed in the following description. Description of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be constructed as limiting the scope of the embodiments herein.

Referring now to preferred embodiments.

The first embodiment describes a method and system for product and/or service recommendation and earning cash-backs/rewards by sharing the product/service URL (Uniform Resource Locator)/link with the others in the network. In one embodiment of the present disclosure, a first user referring a product/service (referrer) and a second user (receiver) referred by the first user gets a cash-back upon purchase of the recommended product/service by the receiver. That is, both the referrer and the receiver will get a cash-back on purchase of the recommended products/services.

In one embodiment of the present disclosure, the system comprises a central server which keeps track of the referrer and the receiver/purchaser by associating a shared product/service link with an identifier of the referrer and the receiver. That is, a social hub application executing on the server/processor modifies the product URL into an affiliate URL wherein the affiliate URL includes referrer and receiver identifiers.

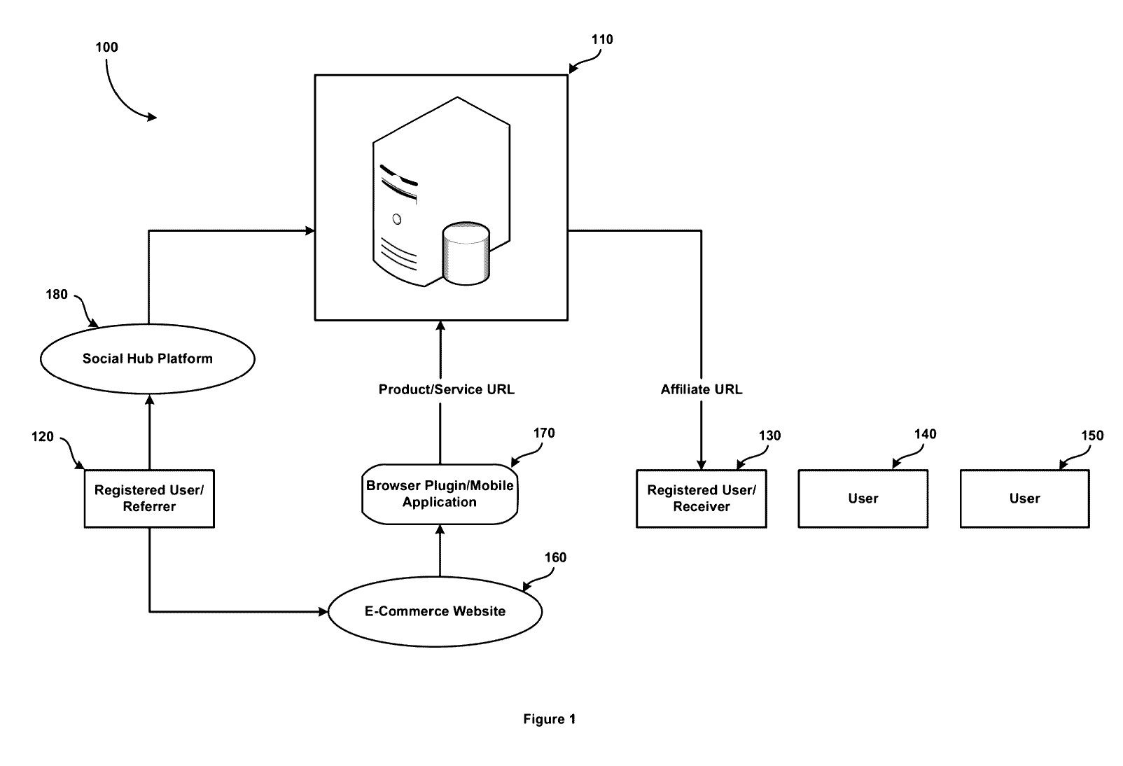

FIG. 1 is a block diagram of an example recommendation system illustrating a recommendation flow in one embodiment of the present disclosure. As shown, the recommendation system 100 comprises a central server 110 with social hub application which facilitates at least one registered first user 120 to endorse or recommend a product or a service to at least one second user 130 among plurality of users 130, 140 and 150) of his/her network from an e-commerce website 160 and allocates a cash-back to both the first user 120 and the second user 130. Hereafter, first user is referred as a “refer” and the second user is referred as a “receiver” for better understanding. In one embodiment, the central server 110 comprises a processor which may be of any type for example, a general purpose processor, server processor, single or multi-core processor etc., and a memory unit for storing the registered user information, recommendation data, mapping data etc.

As illustrated, a first register user 120 of the social hub platform visits a network resource i.e., any e-commerce website 160, browse and finds a product/service that he/she wishes to recommend to a second user 130 wherein the second user is social network member of the first user. On selecting a product/service, the first user 120 (referrer) transfers the URL of the network resource i.e., product/service URL to the central server 110 using a browser plug-in 170. In one embodiment of the present disclosure, a referrer browsing the products/services through the Smartphone uses a client mobile application 170 to transfer the product/service URL to the central server 110.

The central server 110 on receiving the product/service URL identifies the referrer 120 and generates an affiliate URL comprising the traceable information wherein the traceable information comprises referrer identity, receiver identity and product/service details with network resource locator. Then the central server 110 forwards the affiliate URL to the potential purchaser/receiver 130 as illustrated in FIG. 1. In one embodiment of the present disclosure, the central server 110 maintains a mapping between the referrer and the recommended product/service URL, recommended product/service URL and the associated affiliate URL and affiliate URL and the potential receiver. These mappings are bidirectional to track the referrer of a product/service and to allocate a reward or cash-back to both the referrer and the receiver when the receiver makes the purchase.

In another embodiment of the present disclosure, a registered user 120 who wish to refer a product/service may browse for various products/services through a social hub platform 180 which lists products/services from various e-commerce websites.

In vet another embodiment of the present disclosure, the central server 110 maintains a database, which comprises of details regarding recommendations made by each user wherein the details of recommendation includes but not limited to number of recommendations made by the user, number of recommendations consumed (results in purchase), recommendation history which includes recommended products/services, value of product/service, date of purchase, purchase transactions and referral activities over the social hub. In yet another embodiment, the central server 110 computes the referrer cash-back or rewards based on the recommendation details of the referrer and/or the recommendation history. The manner in which user recommends a product/service and avails the reward in described in detail thither below.

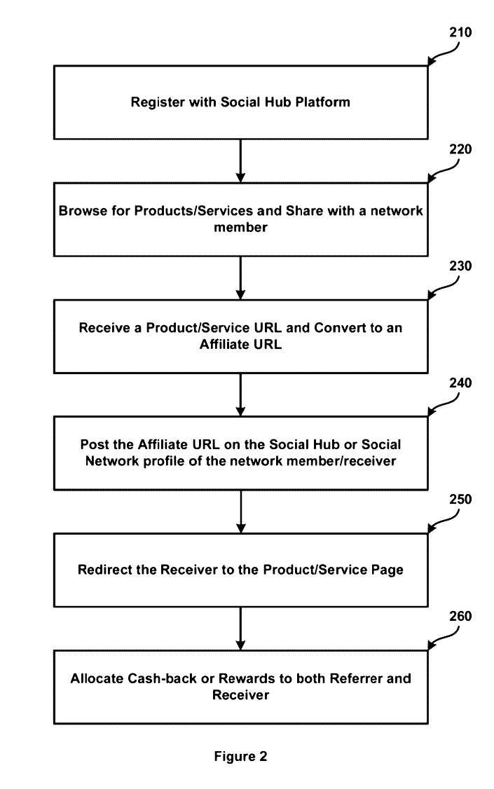

FIG. 2 is a block diagram illustrating the operation of the product/service recommendation in one embodiment of the present disclosure. In step 210, a user registers directly with the social hub platform by providing necessary login credentials such as Username, email ID, contact details etc. On the other hand, the user may register with the social hub platform by providing, any social network login credentials for example Facebook, Gmail, Twitter etc. On registering with the social hub platform, the central server creates a user profile including unique user ID.

In step 220, the registered first user browses for products/services and shares with a network member or second user (receiver). In one embodiment of the present disclosure, a first user i.e., the referrer may recommend the product/service to multiple members of his/her network. The registered user who wishes to refer a product/service (hereafter referred as referrer) browses through any e-commerce website and clicks on the “share” button provided next to the product/service to recommend that product/service.

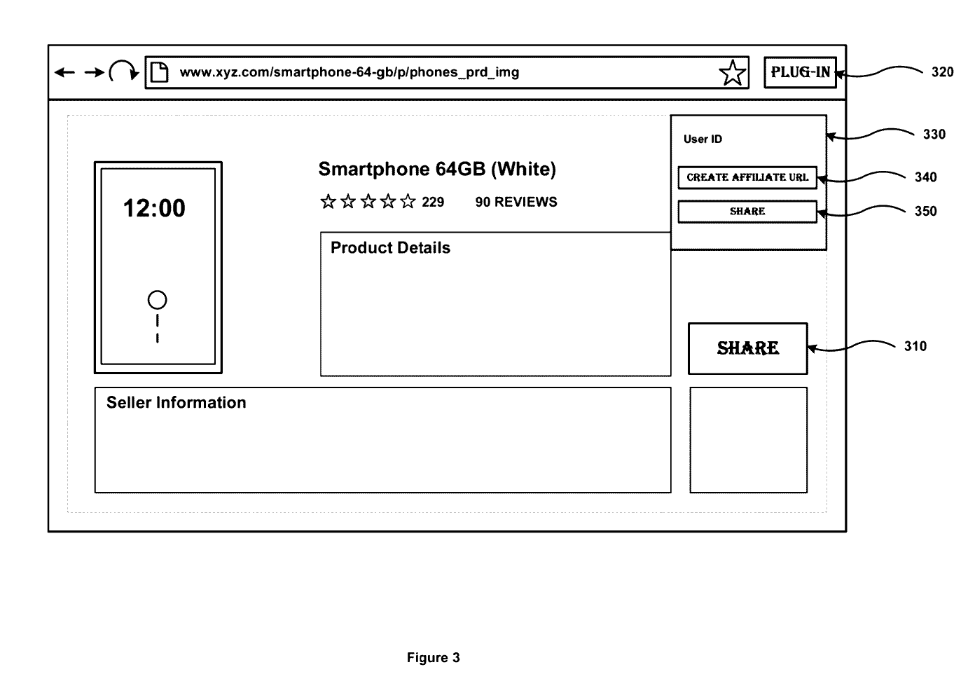

FIG. 3 is an example product/service window showing social hub plug-in in one embodiment of the present disclosure, As shown, the referrer may select any product for example a Smartphone and click on “Share” button 310 provided on the webpage to recommend the product to a receiver (contact) in his/her social network. On clicking on the “share” button 310, the e-commerce channel/website redirects the referrer to a login window of the social hub platform where the referrer may provide necessary login credentials. On successful login, the platform redirects the referrer to a next window where he/she may select the potential recipient/receiver from his/her social network, On the other hand, the referrer may select the potential receiver during login itself in the login window/page.

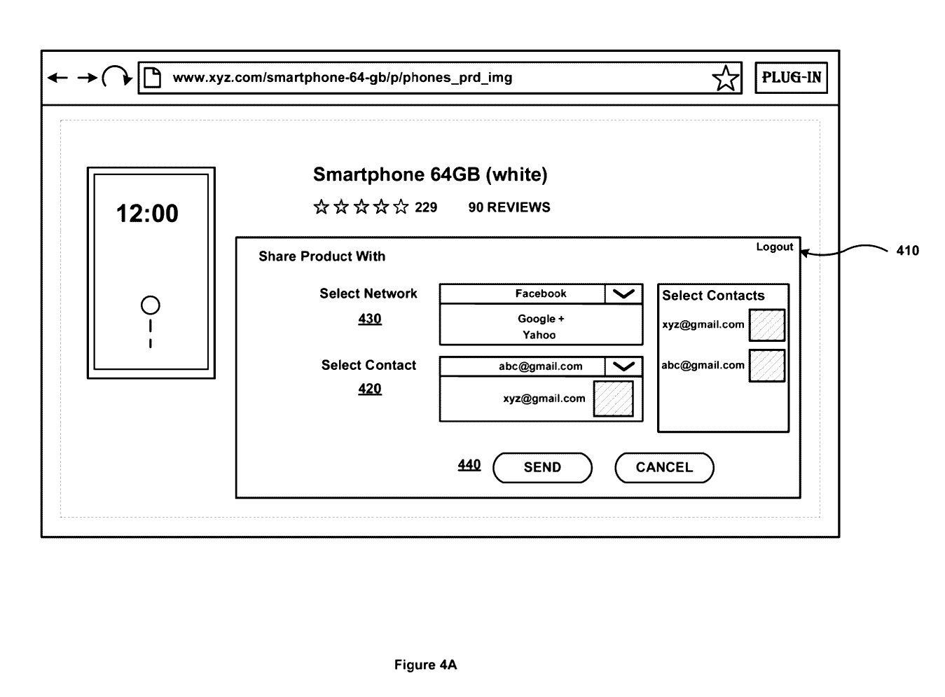

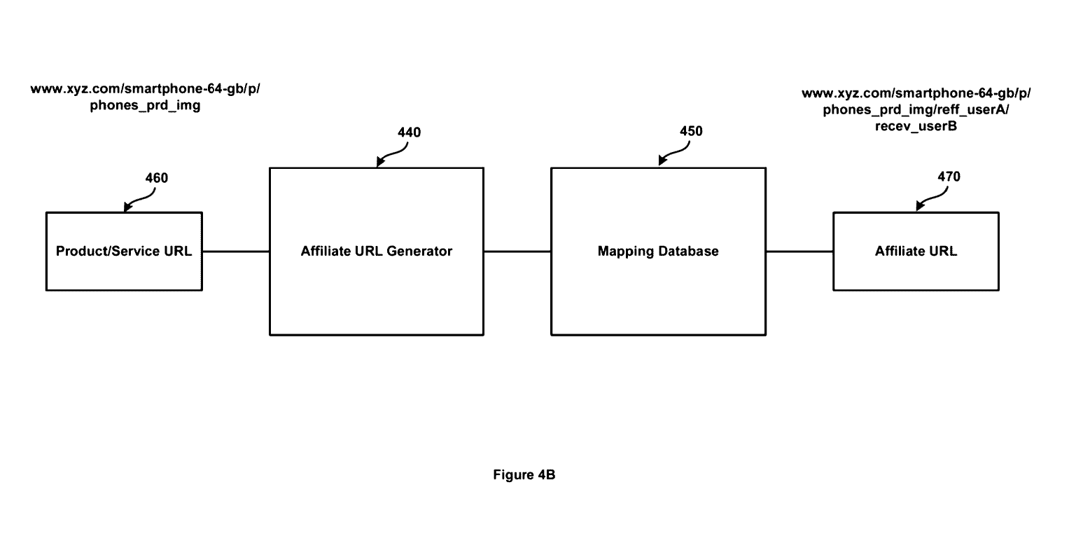

In one embodiment of the present disclosure, a registered user may use a dedicated browser plug-in to share a product/service available on the e-commerce website. As shown, the user may install a dedicated browser plug-in 320 on the web browser and during referring the referrer may use the dedicated browser plug-in 320 to recommend the selected product. On clicking on the dedicated browser plug-in 320, a drop down window 330 opens up and provides an option to create affiliate URL and share the same. As shown, the user may click on “generate affiliate URL” option 340 which generates an affiliate URL for that marketplace on the fly and the user may click on “share” option 350 to share the selected product/service with any of the network member. On clicking on share option the platform redirects the referrer to a next window (shown in FIG. 4A) where he/she may select the potential recipient/receiver from his/her social network. Hence the dedicated plug-in eliminates the necessity of user login every time before making any reference.

Further, the user may utilize the browser plug-in 320 to make the purchase from any e-commerce website. Generally, the user who wish to get the reward for his/her own purchases needs to purchase the product through the social hub platform i.e., the user needs to open the social hub platform, search for the product/service website, search for the product/service in that website and then make the purchase to get the reward. Such process is lengthy, time consuming and hence each user may not prefer the same. In one embodiment of the present disclosure, the user may click on browser plug-in 320 to get the reward/cash-back for his/her own purchases without leaving the product or service webpage. For example, if a user wishes to make a purchase of product “X” from a website “Y” which he/she is browsing, the user just needs to click on the browser plug-in 320 before buying the product “X”. Then the browser plug-in 320 generates an affiliate URL for the user on the fly and hence enables the user to get the reward for the purchase that he/she made. Hence the browser plug-in 320 reduces couple of steps involved in process of getting reward for own purchase and/or while making recommendation for other users or network members.

In one embodiment of the present disclosure, the referrer selects any one contact from the available contact list of his/her social network as recipient. However, the referrer may select multiple contacts from the available contact list of the social network as recipients/receivers. On the other hand, the referrer may manually enter the contact details of the potential recipient. FIG. 4A is an example social hub platform window enabling the referrer to select one or more receivers/recipients in one embodiment of the present disclosure. When the referrer provides the necessary login credentials, social hub platform window 410 pops-up on the product page as shown. The referrer may select one or more network members/contacts using “select contact” drop down box 420 from one or more social network using “select network” option 430. On selecting the receivers, the referrer may send the recommendations by clicking on the “send” option 440.

Referring back to FIG. 2, in step 230, the central server receives the product/service URL and converts to an affiliate URL. In one embodiment of the present disclosure, the central server associates the shared product/service URL with an identifier of the referrer and the receiver. Hence, the affiliate URL comprises tracking information of both the referrer and the receiver.

FIG. 4B illustrates an example system for affiliate URL generation in one embodiment of the present disclosure. As shown, the server comprises an affiliate URL generator 440 for generating affiliate URL 470 from the product/service URL 460 and a mapping database 450 for maintaining a correspondence between the product URL 460 and the affiliate URL 470 wherein the affiliate URL comprises referrer ID and the receiver ID. Such affiliate URL is redirected to the receiver and posted on the social wall.

In one embodiment of the present disclosure, the central server maintains (mapping database) a bidirectional mapping table between the product URL and the affiliate URL. On the other hand, the central server also maintains a mapping table for the referrer, receiver and the affiliate URL to provide cash-back or rewards for the made recommendations and the effected purchases.

In step 240, the central server posts the affiliate URL on the social hub profile page of the receiver. On the other hand, the central server posts the affiliate URL on the social network of the receiver. Further, the referrer may also post the same affiliate on his/her social network page. In one embodiment, the server posts includes referrer details, product related information such as company or website, product name, product picture, price etc.

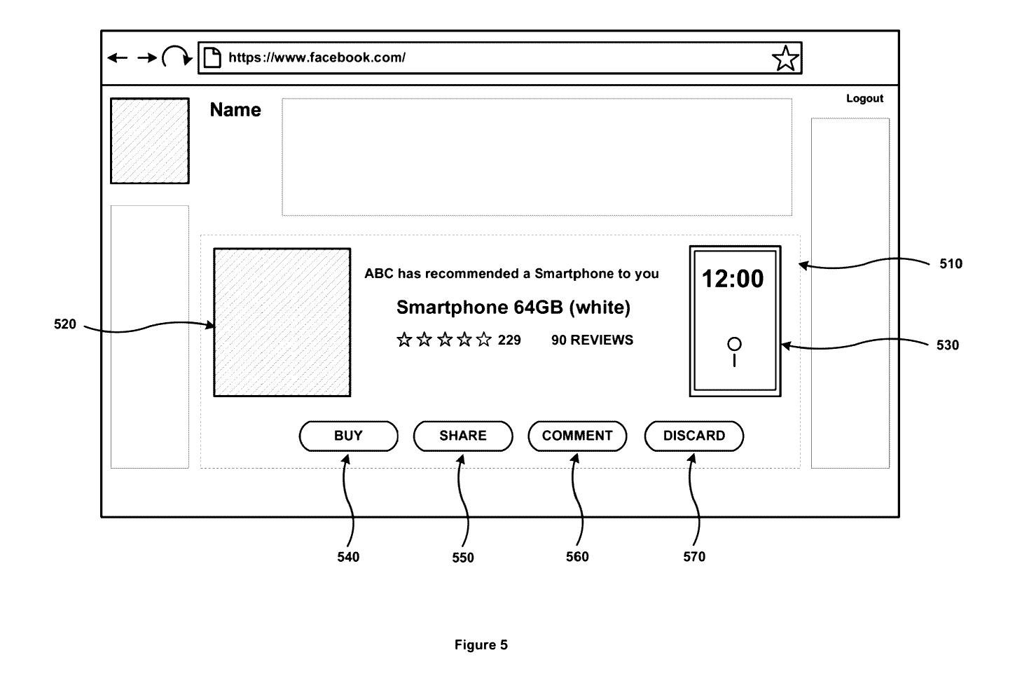

FIG. 5 is an example social network page displaying the recommendation in one embodiment of the present disclosure. As shown, the recommendation from a referrer is displayed on the social network wall 510 of the receiver. In one embodiment, the server posts referrer identification such as referrer photo 520, referrer name, contact details etc. and product information such as product image 530, product description, user rating and reviews etc. The receiver may avail the recommended product/services using a “Buy” option 540 which redirects the receiver to the recommended product page. Similarly, the receiver may share the same product with the other network members of his social network using “Share” option 550 or comment on the product using “Comment” option 560 or may discard the recommendation by clicking on the “Discard” option 570.

In step 250, the central server redirects the receiver to the product/service page. Once the receiver clicks on the “Buy” option on the recommendation window or on the affiliate URL, the server redirects the receiver to the e-commerce website where the receiver may purchase the product. In one embodiment, the central server utilizes the affiliate URL, mapping data and product URL to redirect the receiver to the product/service page.

In step 260, the central server allocates a cash-back or rewards to both the referrer and receiver if the receiver makes the purchase of the referred product/service. In one embodiment, a retailer/e-commerce API detects the sales and updates the same to the central server. The central server comprising the social hub application provides preset cash-back/reward to the purchaser/receiver for availing the product/service, wherein the cash-back/reward may be provided by the retailer and/or the social hub platform. On the other hand, the central server traces the referrer and also offers a pre-set cash-back/reward to the referrer for the purchase made. Such offered cash-back gets accumulated in the social hub account/profile of the referrer and the receiver/purchaser. For example, a person shares a product/service available on the website “X” with a person “B”. The recommended product will be displayed on the person “B” social network so that the person “B” may buy the product. If the person “B” buys the product, both person “A” and “B” will get cash-back and/or any reward offered by the seller and/or the social hub platform.

In another embodiment of the present disclosure, the central server computes the referrer cash-back or rewards based on the recommendation history of the referrer which may include but not limited to number of recommendations made by the referrer, number of recommendations resulted in purchase, recommended product/service category, etc. Hence the said method and system for product and/or service recommendation offers cash-backs or rewards for both the referrer and the receiver when the receiver makes the purchase of the recommended product/service. In one embodiment, receiver cash-back may include discount on the recommended product/service, referrer cash-back may include percentage of recommended product's cost, discounts on purchase of similar products, discount on next purchase etc. On the other hand reward may include but not limited to points, coupons, discounts etc.

Further, in one embodiment of the present disclosure, the affiliate URL posted on the social network of the receiver is accessible by the other members of the receiver's network, or any third person including but not limited to selected members of the network, friends of the network members or by the public depending on the privacy setting of the receiver social network and they may also purchase/avail the product/service through the posted affiliate URL. In one embodiment, the retailer/e-commerce API detects the sales and the social hub provides preset cash-back (any incentives) to the potential purchaser, the receiver and the referrer for availing the product/service, wherein the cash-back may be provided by the retailer and/or the social hub platform. In another embodiment, a part of referrer's rewards/incentives is provided to the receiver, i.e., incentives/rewards are shared between the receiver and the referrer.

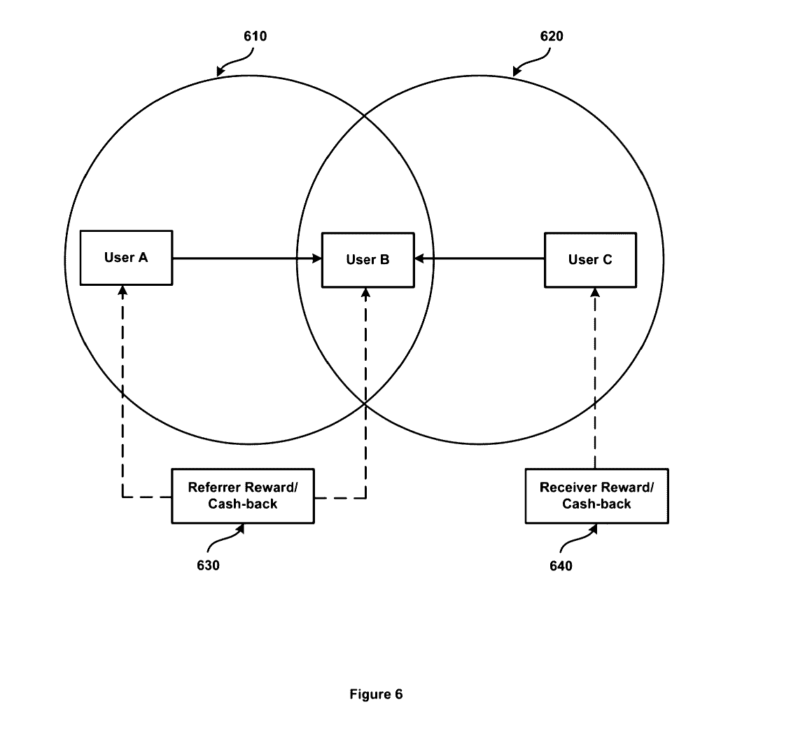

FIG. 6 illustrates an example recommendation flow in one embodiment of the present disclosure. As described above, the affiliate URI posted on the social network of the receiver is accessible by the other members of the receiver's network if the receiver's privacy setting is limited to only friends. As shown, a person (registered user) “A” shares and recommends a product/service available on the website “X” with a person “B” of his/her social network 610. The recommended product will be displayed on the person “B” social network 620, so that the person “B” may buy the product. If a person/user “C” (network member of person “B”) buys the product upon seeing the product display in Ws social network page 620, then a part of the reward belonging to person “A” for providing the recommendation i.e., referrer reward 630 is shared with the person “B” i.e., incentives/rewards 630 are shared between person “A” and “B”. On the other hand, the product purchaser i.e., person “C” gets the purchaser reward 640 for purchasing the referred product/service. Under the cash-back method described under this application, the referrer will get the cash-back for his/her referral only when the receiver and/or any network member of the receiver purchase the particular product under that recommendation/reference. No cash-back will be awarded to the referrer, for the purchases made by the receiver for the products which are not under reference by the referrer. The exact product recommended by the referrer needs to be purchased by the receiver, for the referrer to avail the cask-back benefit. The buyer gets a cash-back in all cases if he goes through this social hub platform.

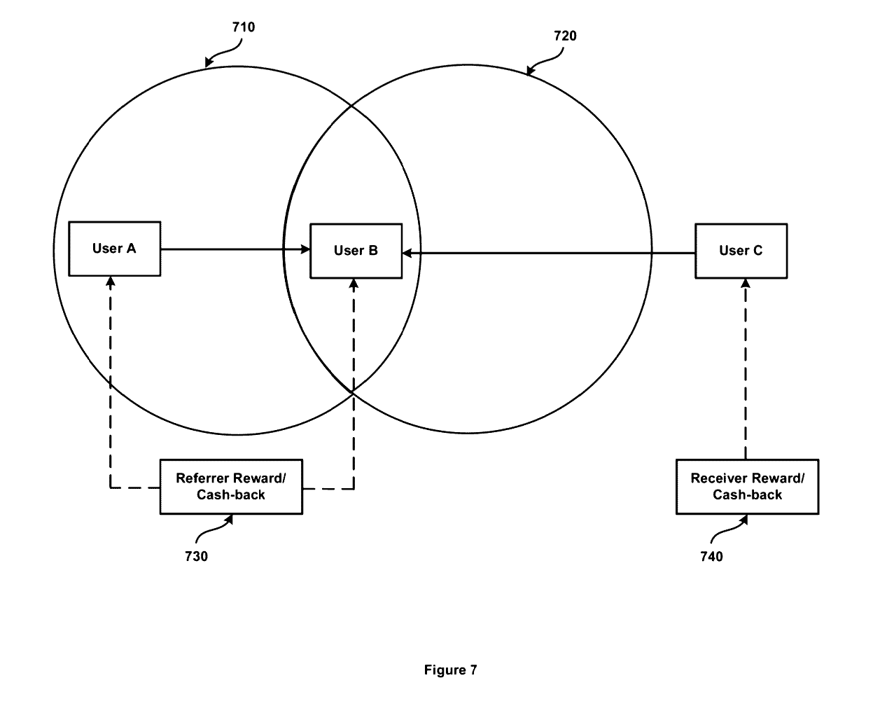

FIG. 7 illustrates another example recommendation flow in one embodiment of the present disclosure. As described in the present disclosure, the affiliate URL posted on the social network of the receiver is accessible by the third person who may be a friend of the network members or by the public (everyone) depending on the privacy setting. As shown, a person (registered user) “A” shares and recommends a product/service available on the website “X” with a person “B” of his/her social network 710. The recommended product will be displayed on the person “B” social network 720, so that the person “B” may buy the product. If a person/user “C” a third person not belonging to either person A or B's network 710 or 720, may buy the product upon seeing the product display in B's social network page 720. Then a part of the reward belonging to person “A” for providing the recommendation i.e., referrer reward 730 is shared with the person “B” incentives/rewards 730 are shared between person “A” and “B”. On the other hand, the product purchaser i.e., person “C” gets the purchaser reward 740 for purchasing the referred product/service. Further, if person “B” recommends a product/service recommended by the person “A” through the same affiliate link with person “D” and if a person “E” makes the purchase through such recommendation, then the referrer reward is shared between person “A”, “B” and “D” and person “E” gets the receiver reward for purchasing the recommended product/service.

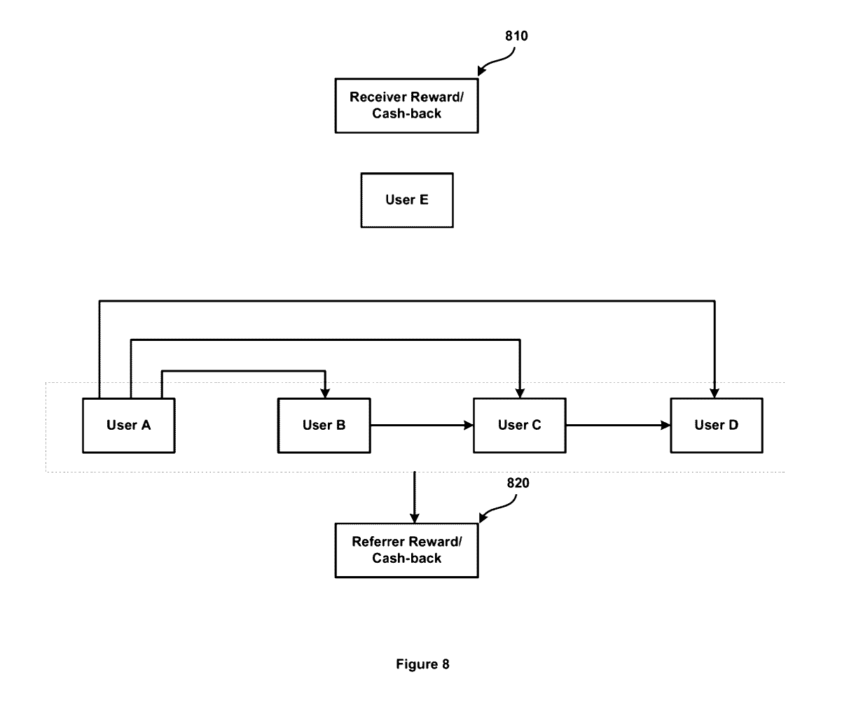

In another embodiment of the present disclosure, a referrer may recommend a particular product or service to multiple users. FIG. 8 illustrates an example of multiple recommendations flow in one embodiment of the present disclosure. As shown, a referrer “A” may recommend a particular product or service to multiple users for example user “B”, “C” and “D” through an affiliate URL. If a user “E” purchases the recommended product through any of such referral, then user “E” gets a receiver reward 810 and the referrer reward is shared between user “A”, “B”, “C” and “D”. For example, the first referrer user “A” receives 50% of the referrer reward and the remaining 50% of the referrer reward is shared between user “B”, “C” and “D” respectively.

In one embodiment of the present disclosure, the central server stores the registered user's data, maintains the recommendations made by the users, recommendations received and executed by the users and transaction details etc. Based on the stored data, the central server analyzes the recommendation data and credits the referrer with additional cash-back towards a product/service or with some additional other incentives. For example, the central server may maintain a count of the number of availed recommendations made by a referrer and credits the referrer with rewards (cash-back, points, discounts, coupons etc.) based on the number of availed recommendations.

In another embodiment of the present disclosure, the central server adopts a multiplier method for computing the cash-back/reward for each registered user by measuring the users activity in the network, which in turn determines the additional incentives that the user is entitled to receive, wherein the user activities may include but not limited to product/service recommendations and sharing, adding users to the network (referral sign-ups), comments and likes etc.

In another embodiment of the present disclosure, the social hub platform provides a micro-gifting option to the registered users. While recommending a product/service to a friend/potential purchaser/receiver in the network, the referrer and/or any person in the purchaser's network may share a portion of their cash-back (micro-gift) from their social hub account to help a potential purchaser to purchase the product/service. The potential purchaser may be a friend or contact in the social network. In one embodiment, the purchaser avails the cash-back (micro-gift) from one or more accounts only when the purchaser purchases the recommended product/service within prescribed time limit. On the other hand, if the purchaser fails to purchase the product/service within pre-set time limit, then the cash-back offered by one or more persons in network will be reverted to their respective social hub accounts.

In another embodiment, the purchaser may utilize the benefit of ‘gifting’ in purchase of recommended product/service wherein, the purchaser gets a product in much reduced price as many of the users in the purchaser's network chose to gift their cash-back/reward with the purchaser for purchasing that particular product. For example, a person “A” wishing to gift a product “X” for person “B” of his network recommends the product “X” and shares a portion of his/her cash-back to buy that product. Similarly, other network members of person “B” may also share a portion of their cash-backs to buy the same product so that the purchaser may get the recommended product in much reduced price.

Hence the said method and system (social-hub platform) enables the users to share products/services online from various e-commerce platforms or aggregator websites with their contacts on the social network. On the other hand, the system facilitates the users to monetize their social network. In addition to recommendation, the said system facilitates the vendors to provide cash-back for any rewards to both the referrer and the purchaser. Hence, increases the website traffic for retailers/vendors and in turn increases the probability of sales.

The foregoing description of the specific embodiments will so fully reveal the general nature of the embodiments herein that others can, by applying current knowledge, readily modify and/or adapt for various applications such specific embodiments without departing from the generic concept, and, thereof, such adaptations and modifications should and are intended to be comprehended within the meaning and range of equivalents of the disclosed embodiments. It is to be understood that the phraseology or terminology employed herein is for the purpose of the description and not of limitation. Therefore, while the embodiments herein have been described in terms of preferred embodiments, those skilled in the art will recognize that the embodiments herein can be practiced with modification within the spirit and scope of the embodiments as described herein.

1. A method for recommending products and services online and earning cash-back/rewards on purchase, the method comprising of:
registering and creating a referrer profile;
selecting at least one product or service for recommendation by the referrer and selecting at least one receiver from the referrer's social contact to recommend the product or service;
receiving by the server, the recommendation from the referrer for at least one product or service wherein the recommendation comprises of a product or service URL;
modifying the recommended product or service URL (Uniform Resource Locator) in to an affiliate URL;
transmitting the recommendation and posting the affiliate URL in the receiver's social network page or social hub Platform page and accessing the recommended product or service details by the receiver;
tracking the response of the receiver to the recommendation and identifying the purchase of the recommended product or service;
computing the pre-set cash-back or reward to be given to the referrer and the purchaser; and
allocating the pre-set cash-back or reward to both the referrer and receiver upon purchase of at least one recommended product or service by the receiver.

2. The method of claim 1 wherein registering and creating a referrer profile in the social hub application is performed directly or through any of referrer's social network login credentials.

3. The method of claim 1 wherein selecting and recommending at least one product or service to at least one receiver is done through the browser plug-in of the social hub application or through the Social hub application web page under this system.

4. The method of claim 1 wherein modifying the product URL into an affiliate link of the social hub application is by associating the shared product URL with an identifier of the referrer and the receiver.

5. The method of claim 1 wherein the affiliate link comprises of tracking information of both the referrer and the receiver.

6. The method of claim 1 wherein the affiliate URL comprises of recommended product or service URL (Uniform Resource Locator), referrer details, product related information which includes company or website, product name, product picture and price.

7. The method of claim 1 wherein accessing the recommended product or service details by the receiver is by clicking on the received affiliate URL and the affiliate URL redirecting the receiver to the e-commerce website comprising product or service details enabling the receiver to purchase the product or further recommend the same to anyone in his social network.

8. The method of claim 1 wherein the response of the receiver to the recommendation includes purchase of the referred product or service, discarding of the recommendation and re-recommendation by the receiver to any of his network members.

9. The method of claim 1 wherein purchasing of the recommended product includes the purchase by the receiver and purchase by a third person who sees the product and buys through the affiliate URL.

10. The method of claim 1 wherein computing cash-back/rewards is based on number of recommendations, recommendation history, purchase transactions, and referral activities over the social hub.

11. The method of claim 1 wherein the referrer is availing the pre-set cash-back or reward for the recommendation only when the receiver or any third person purchases the referred product or service through the referred affiliate URL.

12. The method of claim 1 wherein the receiver is availing the pre-set cash-back or reward for the purchase only when the receiver purchases the recommended product or service referred by the referrer.

13. The method of claim 1 wherein both the referrer and the receiver shares the pre-set cash-back or reward when the recommended product or service is purchased by at least one network member of the receiver or any third person through the affiliate link posted an the receiver's page.

14. The method of claim 13 wherein ally individual network member of the receiver avails the pre-set cash-back or reward besides the referrer and receiver when the network member purchases the recommended product or service referred by the referrer through the affiliate link posted on the receiver's page.

15. A method of micro-gifting products online, to a member in the social network of a registered user, through the social hub platform comprising of:
receiving a request for micro gifting from one of a registered user wherein the request comprises of an offer to gift a product or service, specification of the product to be gilled, receiver of the gift and the amount shared by the requesting user from the social hub account,
notifying the offer in the receiver's social network page or social hub page;
receiving shares from other interested registered user's from their social hub account for the request;
computing the accrued share amount received after a given period of time; and notifying the receiver of the accrued amount, balance amount to be paid for purchase and the final date for accepting the micro-gifting and making a purchase; and
updating the social hub accounts of registered users shared the micro-gifting upon accepting of the offer and purchase of the gifted product by the receiver or return back the share amount to the registered users social hub account.

16. A computer-readable storage medium comprising plurality of instructions wherein the instructions when executed causes the server to perform following operations comprising:
registering and creating a referrer profile;
selecting at least at least one product or service for recommendation and selecting at least one receiver from the referrer's social contact to receive the recommendation;
receiving by the server, the recommendation from the referrer for at least one product or service to a selected receiver wherein the recommendation comprises of a product or service URL;
modifying the recommended product or service URL (Uniform Resource Locator) in to an affiliate URL;
transmitting the recommendation and posting the affiliate URL in the receiver's social network page or social hub Platform page, enabling access of the recommended product or service details by the receiver;
tracking, the response of the receiver to the recommendation and identifying the purchase of the recommended product or service;
computing the pre-set cash-back/reward to be given to the referrer and the purchaser; and
allocating the pre-set cash-back or reward to both the referrer and receiver upon purchase of at least one recommended product or service by the receiver.

17. A system for recommending products or services online and earning rewards on purchase, the system comprising of:
a processor;
a memory operatively connected to the processor; and
a Social Hub application executing on the processor resident in memory and configured to:
register and create a referrer profile;
select at least at least one product or service for recommendation and select at least one receiver from the referrer's social contact to receive the recommendation;
receive the recommendation from the referrer for at least one product or service to a selected receiver wherein the recommendation comprises of a product or service URL;
modify the recommended product or service URL (Uniform Resource Locator) in to an affiliate URL;
transmit the recommendation and post the affiliate URL in the receiver's social network page or social hub Platform page, enabling access of the recommended product or service details by the receiver;
track the response of the receiver to the recommendation and identify the purchase of the recommended product or service;
compute the pre-set cash-back or reward to be given to the referrer and the purchaser; and
allocate the pre-set cash-back or reward to both the referrer and receiver upon purchase of at least one recommended product or service by the receiver.
